(19) United States
(12) Patent Application Publication
(10) Pub. No.: US 2016/0112525 A1
(43) Pub. Date: Apr. 21, 2016

(54) DISTRIBUTION CONTROL DEVICE AND METHOD FOR SAME, PUSH DISTRIBUTION SYSTEM, AND STORAGE MEDIUM

(71) Applicant: NEC CORPORATION, Tokyo (JP)

(72) Inventor: Masahiro KAWATO, Tokyo (JP)

(21) Appl. No.: 14/894,801

(22) PCT Filed: Jun. 2, 2014
(86) PCT No.: PCT/JP2014/002906

§ 371 Date: Nov. 30, 2015

(30) Foreign Application Priority Data
Jun. 10, 2013 (JP) 2013-121437

(51) Int. Cl. H04L 29/08; H04L 12/58; H04L 29/06

(52) U.S. Cl. CPC H04L 67/26; H04L 67/42; H04L 51/26

(57) ABSTRACT

Provided are a distribution control device, etc., in which, when information is distributed, said distribution can be effectively controlled. The distribution control device (1) is provided with: an information receiver (2) that determines a priority degree as transmission-request information (101) is received and performs reception processing in response to the result of said determination; and an information transmitter (3) that determines at regular prescribed time intervals whether a predetermined distribution time has been reached and acquires one or more first address IDs from amongst transmission information (103) when the predetermined distribution time is determined to have been reached, or acquires a first address ID from amongst transmission-request information (101) when the priority degree of the information is indicated as high, and distributes one or more messages by implementing distribution processing on the basis of the acquired one or more first address IDs.

### TECHNICAL FIELD

The present invention relates to a technical field in which various information, such as texts, videos, images, and messages, is efficiently distributed.

### BACKGROUND ART

In communication methods performed between a server device and client terminals, such as portable terminal devices or personal computers, a pull type and a push type exist. The pull type is a method in which a client terminal acquires information from the server device, for example, according to a request from a user. The push type is a method in which information is distributed from the server device to client terminals without depending on a request from the user.

More specifically, for example, the pull type communication is used for the browsing of the Web pages, video on demand (hereinafter, termed “VOD”) or the like.

The push type communication is used for notification of new mail arrival, incoming calls in voice calls, or the like.

As related technologies existing prior to the filing of the present application, for example, PTL 1 discloses a technology related to a push type information distribution method, a program for push type information distribution, and a push type information distribution device.

The push type information distribution device disclosed in PTL 1 chooses a distribution method on the basis of the kinds of messages to be distributed and a communication environment between a client terminal and a server device.

More specifically, the push type information distribution device chooses one distribution mode from among a best-effort mode, a deferred mode, and a timer mode, according to the communication environment between the client terminal and the server device. Then, the push type information distribution device switches to a chosen distribution mode.

Therefore, the push type information distribution device disclosed in PTL 1 is able to distribute information to client terminals whose communication environment is good, without being affected by a client terminal whose communication environment is bad. That is, the push type information distribution device is able to prevent an event in which information distribution to client terminals is delayed.

Next, PTL 2 discloses a technology related to a contents provision system, a contents provision method, and a contents provision program.

The contents provision system disclosed in PTL 2 generates push information that gives an instruction that a push application be startable in a client terminal. This contents provision system transmits the generated push information to the client terminal.

The client terminal receives the push information. The client terminal starts the push application on the basis of the received push information. Furthermore, the client terminal displays contents information contained in the received push information, such as a document or an image, in a display unit.

In other words, the contents provision system is able to immediately distribute contents information to client terminals.

The push distribution system disclosed in PTL 3 selects contents information to distribute, on the basis of a schedule acquired from a schedule server that manages a schedule of a user.

### CITATION LIST

### Patent Literature

[PTL 1] Japanese Laid-open Patent Publication No. 2002-278862

[PTL 2] Japanese Laid-open Patent Publication No. 2009-157650

[PTL 3] Japanese Laid-open Patent Publication No. 2005-165697

### SUMMARY OF INVENTION

### Technical Problem

By the way, as a service that utilizes the foregoing push type communication, a push distribution service is commonly known.

FIG. 8 is a diagram conceptually exemplifying a push distribution system 200 that provides a commonly known push distribution service.

In FIG. 8, the push distribution system 200 includes an application server 201, a push server 202, and a client terminal 203.

In the following, for example, it is assumed that the application server 201 distributes a message to the client terminal 203, the application server 201 transmits to the push server 202 push transmission request information that contains a message body and information that represents the destination of the message.

The push server 202 accumulates the push transmission request information. On the basis of the push transmission request information accumulated, the push server 202 distributes the message to the client terminal 203.

When techniques for the push server 202 to distribute the message are roughly classified, there exist an accumulative processing mode and an immediate processing mode.

More specifically, the immediate processing mode receives push transmission request information. Then, on the basis of the received push transmission request information, the immediate processing mode immediately distributes the message.

FIG. 9 is a diagram exemplifying transition in the state of communication when the commonly known client terminal 203 receives two messages from the push server 202 (immediate processing mode).

More specifically, FIG. 9 represents time in a horizontal axis direction. FIG. 9 represents the state of connection (connection or disconnection) of a communication network in a vertical axis direction.

The push server 202, in response to receiving push transmission request information, immediately distributes two messages to the client terminal 203.

Therefore, in the immediate processing mode illustrated in FIG. 9, connection between the client terminal 203 and the push server 202 needs to be established every time the message is distributed. Furthermore, even when the distribution of the message is completed, the state of connection between the client terminal 203 and the push server 202 continues over a certain time.

More specifically, as connection processing, for example, a three-way handshake, an RRC (radio resource control), and the like are commonly known. The three-way handshake is a procedure that establishes connection between the client terminal and the server device in the TCP (Transmission Control Protocol). The RRC is a technology that controls wireless resources based on occurrence of data communication.

Thus, the immediate processing mode can lessen the delay in distributing the message. On another hand, in the immediate processing mode, the connection processing at the time of distributing the message tends to increase. In other words, in the immediate processing mode, the load on the communication network and the electric power consumption at the client terminal and the push server cannot be reduced. In particular, the client terminal 203, such as a portable terminal device, cannot restrain exhaustion of the battery. Therefore, at the client terminal 203, deterioration of usability for its user is likely to result.

Next, the accumulative processing mode accumulates push transmission request information. Then, the accumulative processing mode distributes messages to the client terminal 203 on the basis of the accumulated push transmission request information in every predetermined time period.

FIG. 10 is a diagram exemplifying transition of the communication state when a commonly known the client terminal 203 receives two pieces of data from the push server 202 (accumulative processing mode).

More specifically, FIG. 10 represents time in a horizontal axis direction. FIG. 10 represents the connection state of a communication network in a vertical axis direction.

The push server 202 receives push transmission request information. Then, the push server 202 accumulates the push transmission request information received. On the basis of the accumulated push transmission request information, the push server 202 distributes messages to the client terminal 203 in every predetermined time period.

Therefore, in the accumulative processing mode illustrated in FIG. 10, connection is established between the client terminal 203 and the push server 202 when accumulated messages are to be distributed. This allows the push server 202 to distribute two messages.

Thus, the accumulative processing mode can restrain increases of the foregoing connection processing. On another hand, the accumulative processing mode tends to increase the delay at the time of distributing messages. In other words, in the accumulative processing mode, the load on the communication network and the electric power consumption of the client terminal 203 and the push server 202 can be reduced. In particular, at the client terminal 203, exhaustion of the battery can be restrained.

In PTL 1, the best-effort mode and the deferred mode correspond to the immediate processing mode. Moreover, the timer mode corresponds to the accumulative processing mode.

In other words, PTL 1 merely discloses a technology that switches the processing mode between the accumulative processing mode and the immediate processing mode according to the communication environment of the client terminal and the push server. PTL 1 does not have a measure for guaranteeing an order for distribution when messages are distributed by a combination of the accumulative processing mode and the immediate processing mode. Therefore, in PTL 1, there is a risk that when messages are displayed at the client terminal, the messages may possibly not be displayed in an order intended by an information source.

The push type information distribution device disclosed in PTL 1 distributes information by the immediate processing mode even if the information is not important to the user or the information source. Therefore, in PTL 1, the load on the communication network and the electric power consumption can still not be reduced.

PTL 2 merely discloses a technology that immediately distributes contents. PTL 2 does not consider nor mention anything about reduction of the electric power consumption or restraint of increases in the communication network load.

One of a main object of the present invention is to provide a distribution control device and the like that, when distributing information, can efficiently control the distribution.

### Solution to Problem

In order to solve the foregoing problem, a distribution control device in accordance with the present invention is characterized by including a configuration as follows.

A distribution control device comprising: an information reception unit configured to, in response to receiving transmission request information that contains a destination ID capable of identifying a terminal that is a distribution target, a body of a message, and priority degree information that indicates a priority degree set for the message, determine the priority degree on the basis of the priority degree information, and to execute one of reception processing of high-priority degree information or reception processing of low-priority degree information in accordance with a result of determination; and an information transmission unit configured to refer to transmission information containing the destination ID and scheduled date and time of distribution of the message at every predetermined time period, and to acquire at least one first destination ID associated with the scheduled date and time of distribution from the transmission information when the date and time of referring to the transmission information reaches the scheduled date and time of distribution, if it is indicated that the priority degree information is high, to acquire a first destination ID in the transmission request information, and to distribute the at least one message by executing a distribution processing on the basis of the at least one first destination ID acquired.

Alternatively, the foregoing object can be achieved by a push distribution system that includes the distribution control device presented above.

Moreover, in order to achieve the foregoing object, a distribution control method in accordance with the present invention is characterized by including a configuration as follows.

A distribution control method by an information processing apparatus comprising:

in response to receiving transmission request information that contains a destination ID capable of identifying a terminal that is a distribution target, a body of a message, and priority degree information that indicates a priority degree set for the message, determining the priority degree on the basis of the priority degree information, and executing one of reception processing of high-priority degree information or reception processing of low-priority degree information in accordance with a result of determination and

referring to transmission information containing the destination ID and scheduled date and time of distribution of the message at every predetermined time period, and acquiring at least one first destination ID associated with the scheduled date and time of distribution from the transmission information when the date and time of referring to the transmission information reaches the scheduled date and time of distribution, if it is indicated that the priority degree information is high, acquiring a first destination ID in the transmission request information, and

distributing the at least one message by executing a distribution processing on the basis of the at least one first destination ID acquired.

Note that the foregoing object is also achieved by a computer program that realizes via a computer the distribution control device and the distribution control method that have configurations described above and a computer-readable storage medium in which that computer program is stored.

### Advantageous Effects of Invention

According to the present invention, the distribution control device and the like that, when distributing information, can efficiently control the distribution can be provided.

### BRIEF DESCRIPTION OF DRAWINGS

FIG. 1 is a block diagram illustrating a configuration of a distribution control device in a first exemplary embodiment of the present invention.

FIG. 2 is a diagram concretely exemplifying a configuration of reception information in the first exemplary embodiment of the present invention.

FIG. 3 is a diagram concretely exemplifying a configuration of transmission information in the first exemplary embodiment of the present invention.

FIG. 4 is a flowchart illustrating an operation that is performed by an information reception unit of the distribution control device in the first exemplary embodiment of the present invention.

FIG. 5 is a flowchart illustrating an operation that is performed by an information transmission unit of the distribution control device in the first exemplary embodiment of the present invention.

FIG. 6 is a block diagram illustrating a configuration of a push distribution system that includes a distribution control device in a second exemplary embodiment of the present invention.

FIG. 7 is a block diagram exemplarily illustrating a hardware configuration of an information processing apparatus capable of realizing various exemplary embodiments of the present invention.

FIG. 8 is a diagram conceptually exemplifying a push distribution system that provides commonly known push distribution services.

FIG. 9 is a diagram exemplifying transition of the state of communication when a commonly known client terminal receives two messages from a push server (immediate processing mode).

FIG. 10 is a diagram exemplifying transition of the communication state when a commonly known a client terminal receives two pieces of data from a push server (accumulative processing mode).

### DESCRIPTION OF EMBODIMENTS

Hereinafter, exemplary embodiments of the present invention will be described in detail with reference to the drawings.

### First Exemplary Embodiment

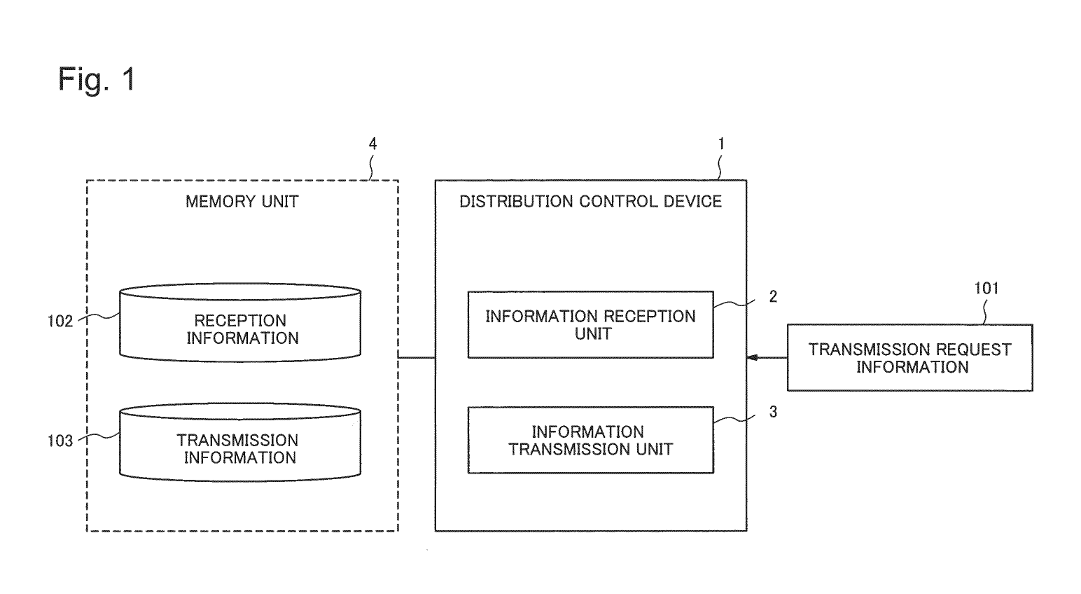

FIG. 1 is a block diagram illustrating a configuration of a distribution control device 1 in a first exemplary embodiment of the present invention.

In FIG. 1, the distribution control device 1 includes an information reception unit 2 and an information transmission unit 3.

More specifically, the information reception unit 2, in response to receiving transmission request information 101, sets a message identifier (hereinafter, termed “ID”) capable of identifying the transmission request information 101.

The transmission request information 101 is, for example, information that contains a destination ID capable of identifying a client terminal that is a distribution target for the message, a body (entity) of the message, and priority degree information that indicates the priority degree set for the message.

Furthermore, the information reception unit 2 stores (accumulates) the transmission request information 101 received, the set message ID, the date and time at which the transmission request information 101 is received, and distribution state information indicating whether or not distribution of information has been completed (non-distribution) in reception information 102 of a storage unit 4.

Note that in the following description, for convenience in description, the date and time at which the transmission request information 101 was received will be termed “date and time of request”, as an example.

When the message has been distributed, the information reception unit 2 stores information “completion” indicating that the message has been distributed into the distribution state information.

Furthermore, when the message has not been distributed, the information reception unit 2 stores information “non-completion” indicating that the message has not been distributed (non-distribution) into the distribution state information.

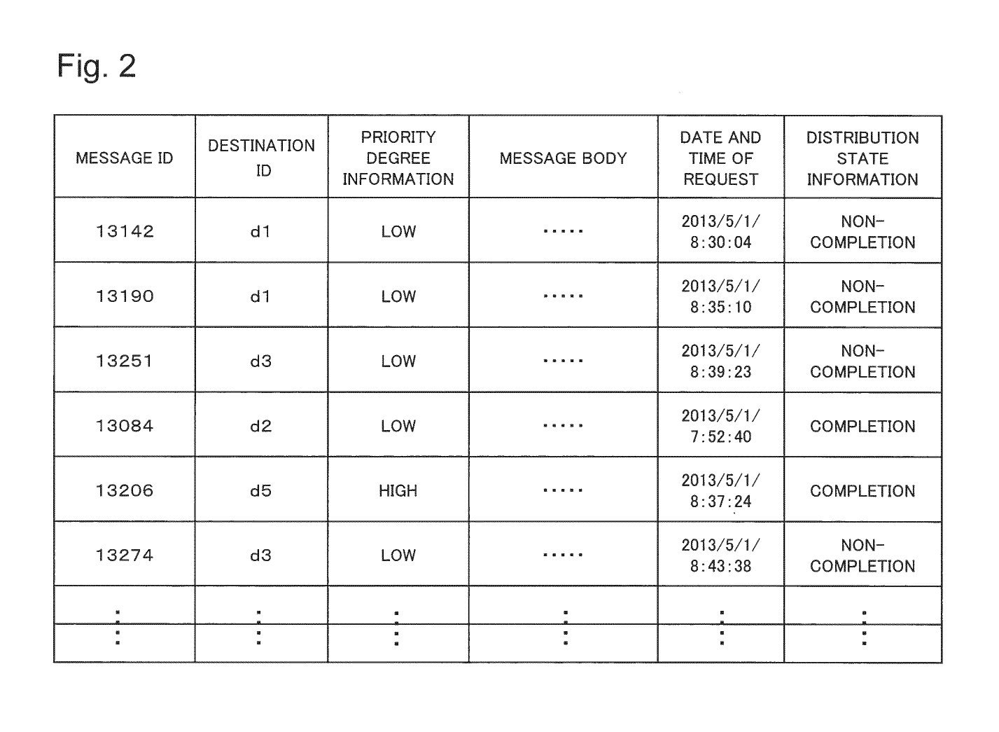

FIG. 2 is a diagram concretely exemplifying a configuration of the reception information 102 in the first exemplary embodiment of the present invention.

In a table exemplified in FIG. 2, the reception information 102 indicates message IDs in the first column. The second column indicates destination IDs. The third column indicates priority degree information. The fourth column indicates message bodies. The fifth column indicates dates and times of request. The sixth column indicates distribution state information.

In other words, the reception information 102 is information in which using the message ID as a key, the destination ID, priority degree information, the body of a message, date and time of request, and distribution state information are associated.

Note that the priority degree information may adopt, for example, a configuration in which the priority degree is indicated by two pieces of information (“high” and “low”). Moreover, priority degree is assumed to mean, for example, the importance of the message.

The information reception unit 2 determines the priority degree set for the message on the basis of priority degree information contained in the transmission request information 101.

The information reception unit 2, according to the result of determination of the priority degree on the basis of the priority degree information, executes one of reception processing of high-priority degree information or reception processing of low-priority degree information. Note that the reception processing of high-priority degree information or the reception processing of low-priority degree information will be described later in conjunction with the present exemplary embodiment.

The information transmission unit 3 executes processing described below when the priority degree represented by the priority degree information indicates that the priority degree is “high” or at every predetermined time period.

Note that for convenience in description, the present application abbreviates the “priority degree represented by the priority degree information” simply as “priority degree information”.

The information transmission unit 3, in response to receiving from the information reception unit 2 a notification that the priority degree information contained in the reception information 102 is “high”, acquires the destination ID (first destination ID) contained in the transmission request information 101. In other words, when it is indicated that the priority degree information is “high”, the information transmission unit 3 acquires the destination ID (first destination ID) contained in the transmission request information 101.

Note that in the following description, for convenience in description, the destination ID that is acquired by the information transmission unit 3 will be termed first destination ID (which applies in the exemplary embodiments described below).

On another hand, the information transmission unit 3, at every predetermined time period, refers to the transmission information 103 stored in the storage unit 4.

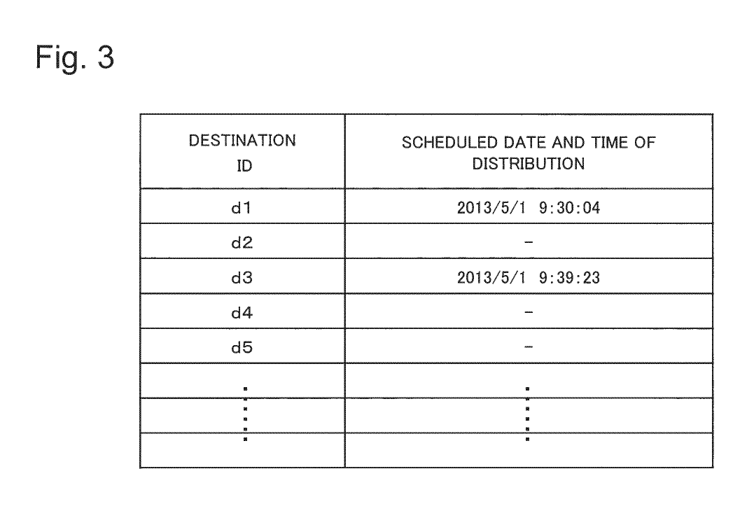

FIG. 3 is a diagram concretely exemplifying a configuration of the transmission information 103 in the first exemplary embodiment of the present invention.

In a table exemplified in FIG. 3, the transmission information 103 indicates destination IDs in the first column. The second column indicates scheduled dates and times of distribution. In other words, the transmission information 103 is information in which the destination ID and scheduled date and time of distribution are associated.

Note that the scheduled date and time of distribution is information that indicates the scheduled date and time when the message is to be distributed.

More specifically, as an example, in the second line in the table (the transmission information 103) illustrated in FIG. 3, the scheduled date and time of distribution associated with the destination ID “d1” are “2013/5/1, 9:30:04”. In other words, it means that the distribution control device 1 distributes messages to the client terminal that has the destination ID “d1” at “2013/5/1, 9:30:04”.

The information transmission unit 3 determines whether or not the date and time of referring to the transmission information 103 has reached the scheduled date and time of distribution contained in the transmission information 103.

Note that in the following description, for convenience in description, the date and time of referring to the transmission information 103 will be simply termed the “date and time of reference”.

When the information transmission unit 3 determines that the date and time of reference has reached the scheduled date and time of distribution, the information transmission unit 3 acquires at least one first destination ID associated with the scheduled date and time of distribution from the transmission information 103. In other words, the information transmission unit 3 acquires the first destination IDs associated with all the scheduled date and time of distribution that the date and time of reference has reached, from the transmission information 103.

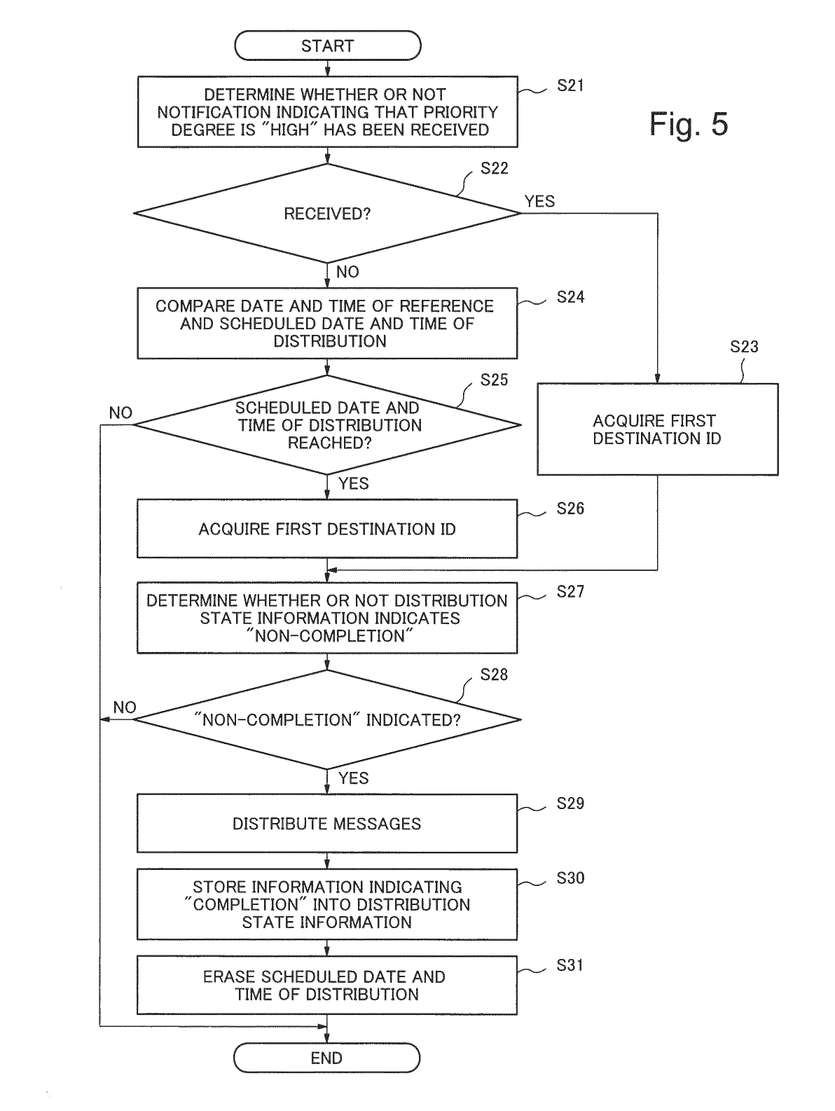

Furthermore, the information transmission unit 3, on the basis of the at least one first destination ID, executes a distribution processing (step S27 to step S31 in FIG. 5) (the distribution processing will be described below in conjunction with the present exemplary embodiment).

The storage unit 4 stores the reception information 102 and the transmission information 103.

Note that the storage unit 4 is a storage device that a computer can read data from and write date in. More specifically, as an example, the storage unit 4 can adopt a storage device, such as a hard disk drive, a DRAM (dynamic random access memory), etc., that is mounted in an electronic appliance such as a server device.

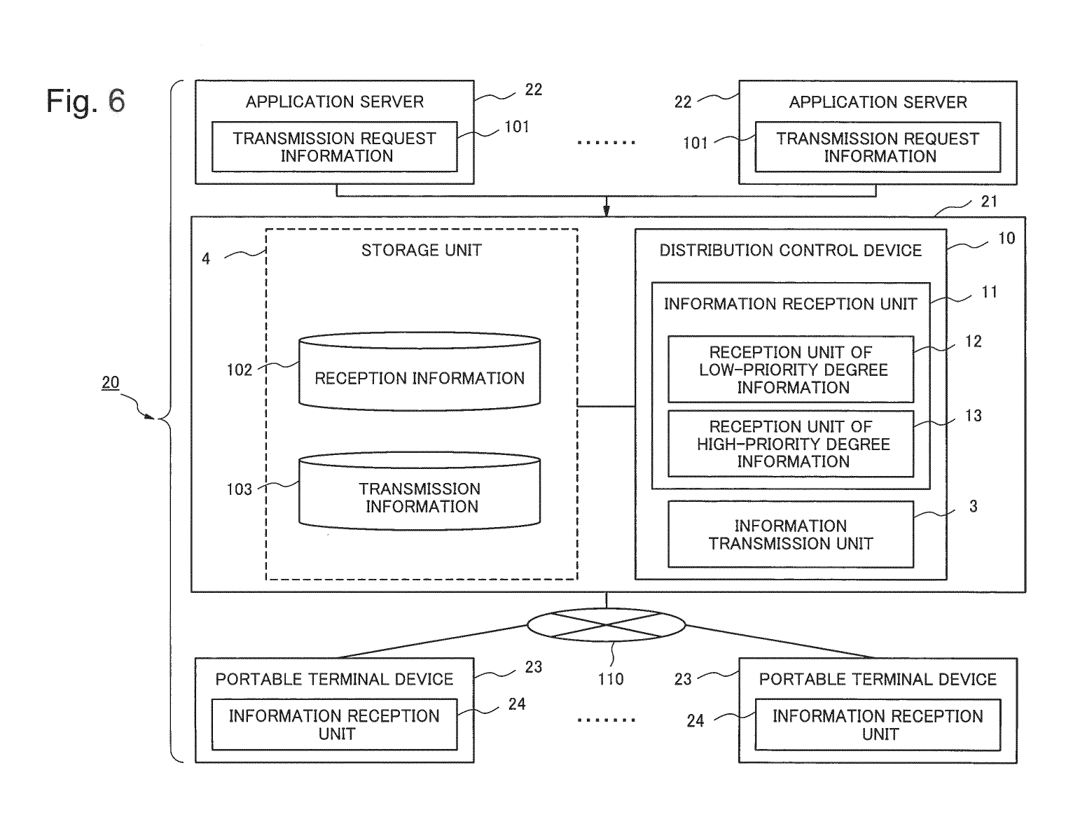

As an example, as for the storage unit 4, it is permissible to adopt a storage device (not graphically illustrated) connected to a communication network that is not graphically illustrated (e.g., a communication network 110 illustrated in FIG. 6). However, the present invention described above using the present exemplary embodiment as an example is not limited by the foregoing configurations (which likewise applies to the following exemplary embodiments).

A more concrete operation of the distribution control device 1 in accordance with the first exemplary embodiment of the present invention will be described.

In the following description, an operation performed when the distribution control device 1 has received the transmission request information 101 will be described in detail as an example.

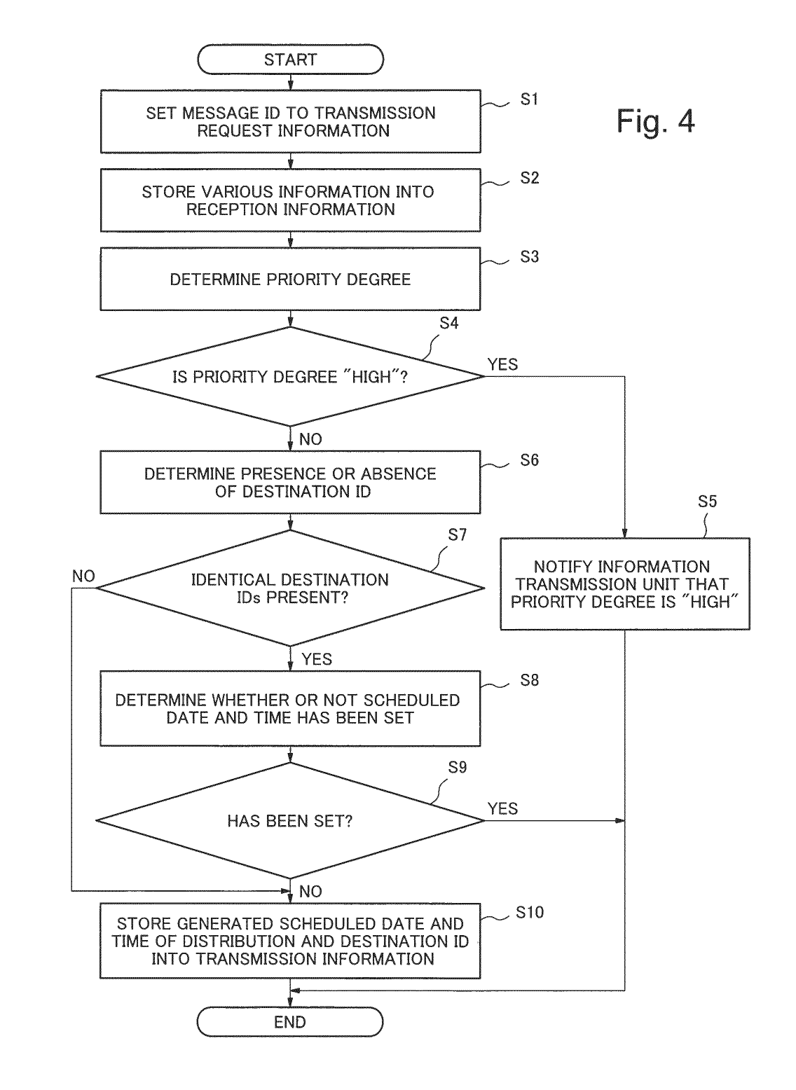

FIG. 4 is a flowchart illustrating an operation that is performed by the information reception unit 2 of the distribution control device 1 in the first exemplary embodiment of the present invention. In the following description, an operation procedure of the information reception unit 2 will be described in accordance with the flowchart.

Step S1: The information reception unit 2 receives the transmission request information 101. Then, the information reception unit 2 sets a message ID that is capable of identifying the received transmission request information 101.

More specifically, the information reception unit 2, for example, may adopt a configuration in which the message ID is generated by combining a value of a counter and a host name that identifies the server device. However, the present invention described above using the present exemplary embodiment as an example is not limited by the foregoing configurations (which likewise applies to the following exemplary embodiments).

Step S2: The information reception unit 2 stores the transmission request information 101, the message ID, the date and time of request, and the distribution state information into the reception information 102 of the storage unit 4.

More specifically, the information reception unit 2 associates the destination ID, the priority degree information, and the body of the message that are contained in the transmission request information 101, and the message ID, the date and time of request, and the distribution state information with each other, and stores them into the reception information 102.

Note that the information reception unit 2 stores information “non-completion” indicating that the message has not been distributed (non-distribution) into the distribution state information.

Step S3: The information reception unit 2 determines the priority degree on the basis of priority degree information contained in the transmission request information 101.

“YES” in step S4: When the information reception unit 2 has determined that the priority degree is high as a result of determination of the priority degree based on the priority degree information, the information reception unit 2 advances the process to step S5. In other words, the information reception unit 2 advances the process to step S5 when it is indicated that the priority degree information is “high” as a result of determination of the priority degree based on the priority degree information.

“NO” in step S4: When the information reception unit 2 has determined that the priority degree is low as a result of determination of the priority degree based on the priority degree information, the information reception unit 2 advances the process to step S6. In other words, the information reception unit 2 advances the process to step S6 when it is indicated that the priority degree information is “low” as a result of determination of the priority degree based on the priority degree information.

Step S5: The information reception unit 2 executes the reception processing of high-priority degree information when it is indicated that the priority degree information is “high”.

More specifically, the information reception unit 2 notifies the information transmission unit 3 that the priority degree information contained in the transmission request information 101 is “high”. Then, the information reception unit 2 ends the process.

Step S6: The information reception unit 2 executes the reception processing of low-priority degree information when it is indicated that the priority degree information is “low”.

More specifically, the information reception unit 2 refers to the transmission information 103 stored in the storage unit 4 on the basis of the destination ID contained in the transmission request information 101. The information reception unit 2 determines whether or not the destination ID is present in the transmission information 103. In other words, the information reception unit 2 determines whether or not the same destination ID is present in the transmission information 103.

“YES” in step S7: When the information reception unit 2 has determined that the destination ID is present in the transmission information 103 as a result of determination about the presence or absence of the destination ID in the transmission information 103, the information reception unit 2 advances the process to step S8.

“NO” in step S7: When the information reception unit 2 has determined that the destination ID is absent in the transmission information 103 as a result of determination regarding the presence or absence of the destination ID in the transmission information 103, the information reception unit 2 advances the process to step S10.

Step S8: The information reception unit 2 acquires the scheduled date and time of distribution associated with the destination ID, from the transmission information 103. Then, the information reception unit 2 determines whether or not scheduled date and time have been set in the scheduled date and time of distribution acquired.

“YES” in step S9: When, as a result of determination as to whether or not the scheduled date and time has been set in the scheduled date and time of distribution acquired, the information reception unit 2 has determined that the scheduled date and time has been set, the information reception unit 2 ends the process.

“NO” in step S9: When, as a result of determination as to whether or not the scheduled date and time has been set in the scheduled date and time of distribution acquired, the information reception unit 2 has determined that the scheduled date and time has not been set, the information reception unit 2 advances the process to step S10.

Step S10: The information reception unit 2 generates scheduled date and time of distribution through predetermined calculation. The information reception unit 2 associates the scheduled date and time of distribution generated and the destination ID, and stores them into the transmission information 103 of the storage unit 4.

The information reception unit 2, for example, may adopt a configuration in which the scheduled date and time of distribution is generated on the basis of the date and time of receiving the transmission request information 101 (date and time of request) and a predetermined time. More specifically, as an example, the information reception unit 2 can calculate the scheduled date and time of distribution “2013/5/1, 9:30:04” on the basis of the date and time “2013/5/1, 8:30:04” of receiving the transmission request information 101 and the predetermined time (e.g., after one hour).

In the following description, an operation performed when the information transmission unit 3 of the distribution control device 1 distributes messages will be described in detail as an example.

FIG. 5 is a flowchart illustrating an operation that is performed by the information transmission unit 3 of the distribution control device 1 in the first exemplary embodiment of the present invention. In the following description, an operation procedure of the distribution control device 1 will be described in accordance with the flowchart.

The information transmission unit 3 executes processing illustrated by step S21 to step 31 presented in FIG. 5 when the information transmission unit 3 has received from the information reception unit 2 the notification that the priority degree information is “high” or at every predetermined time period.

Step S21: The information transmission unit 3 of the distribution control device 1 determines whether or not the information transmission unit 3 has received from the information reception unit 2 the notification indicating that the priority degree information is “high”.

“YES” in step S22: When the information transmission unit 3 has determined that the notification has been received as a result of determination as to whether or not the notification has been received from the information reception unit 2, the information transmission unit 3 advances the process to step S23.

“NO” in step S22: When the information transmission unit 3 has determined that the notification has not been received as a result of determination as to whether or not the notification has been received from the information reception unit 2, the information transmission unit 3 advances the process to step S24.

Step S23: The information transmission unit 3 acquires the first destination ID contained in the transmission request information 101. Then, the information transmission unit 3 advances the process to step S27.

Step S24: The information transmission unit 3 refers to the transmission information 103 stored in the storage unit 4. The information transmission unit 3 compares the date and time of referring to the transmission information 103 (the date and time of reference) and the scheduled date and time of distribution contained in the transmission information 103.

“YES” in step S25: When the information transmission unit 3 has determined the date and time of reference has reached the scheduled date and time of distribution as a result of comparison between the date and time of reference and the scheduled date and time of distribution, the information transmission unit 3 advances the process to step S26. In other words, when the information transmission unit 3 has determined that the date and time of reference is equal to or later than the scheduled date and time of distribution, the information transmission unit 3 advances the process to step S26.

“NO” in step S25: When the information transmission unit 3 has determined that the date and time of reference has not reached the scheduled date and time of distribution as a result of comparison between the date and time of reference and the scheduled date and time of distribution, the information transmission unit 3 ends the process. In other words, when the information transmission unit 3 has determined that the date and time of reference is or earlier than the scheduled date and time of distribution, the information transmission unit 3 ends the process.

Step S26: The information transmission unit 3 acquires the first destination ID associated with the scheduled date and time of distribution from the transmission information 103.

When at least one piece of information that reaches the scheduled date and time of distribution exists in the transmission information 103, the information transmission unit 3 acquires the first destination ID associated with the each scheduled date and time of distribution. In other words, the information transmission unit 3 acquires at least one first destination ID from the transmission information 103.

Step S27: On the basis of the at least one first destination ID acquired, the information transmission unit 3 refers to the reception information 102 stored in the storage unit 4. The information transmission unit 3 determines whether or not the distribution state information associated with the first destination ID contained in the reception information 102 indicates “non-completion”.

“YES” in step S28: When the information transmission unit 3 has determined that the distribution state information indicates “non-completion” as a result of determination as to whether or not the distribution state information indicates “non-completion”, the information transmission unit 3 advances the process to step S29. In other words, the information transmission unit 3 advances the process to step S29 when a not-distributed message exists.

“NO” in step S28: When the information transmission unit 3 has determined that the distribution state information does not indicates “non-completion” (i.e., indicates “completion”) as a result of determination as to whether or not the distribution state information indicates “non-completion”, the information transmission unit 3 ends the process. In other words, the information transmission unit 3 ends the process when a not-distributed message does not exist.

In step S29: The information transmission unit 3 acquires at least one message's body and at least one message ID that are associated with the at least one first destination ID from the reception information 102. Furthermore, on the basis of the at least one first destination ID and the at least one message's body acquired, the information transmission unit 3 distributes at least one message.

Note that when distributing at least one message, the information transmission unit 3 distributes the at least one message so that the at least one message is in chronological order of date and time of request. In other words, the information transmission unit 3 distributes one or more messages so that the messages are in the order in which one or more pieces of transmission request information 101 were received by the distribution control device 1.

More specifically, as an example, the information transmission unit 3 refers to at least one date and time of request associated with the at least one first destination ID in the reception information 102. Then, the information transmission unit 3 distributes one or more messages so that the messages are in chronological order of date and time of request. This configuration may be adopted.

Then, for example, a configuration in which when distributing messages, the information transmission unit 3 adds information that represents the order into a portion of the data format (i.e., a header of the message) may be adopted. For example, as the information that represents the order, a configuration that includes information indicating the order as in “1, the body of message 1”, “2, the body of message 2”, and “3, the body of message 3” may be adopted. However, the present invention described above using the present exemplary embodiment as an example is not limited by the foregoing configurations (which likewise applies to the following exemplary embodiments).

Step S30: The information transmission unit 3 stores the information that indicates “completion” into the distribution state information contained in the reception information 102.

More specifically, the information transmission unit 3 refers to the reception information 102 on the basis of the at least one message ID acquired in step S29. The information transmission unit 3 stores information that indicates “completion” in the distribution state information associated with the at least one message ID. That is, the information transmission unit 3 stores that the at least one message has been distributed.

Step S31: The information transmission unit 3 refers to the transmission information 103 on the basis of the at least one first destination ID. The information transmission unit 3 resets (i.e., erases) the scheduled date and time of distribution associated with the first destination ID.

Note that although, for convenience in description, description is made using the foregoing configurations as examples, the present invention described above using the present exemplary embodiment as an example is not limited by the foregoing configurations. For example, the distribution control device 1 may adopt a configuration that distributes information that contains texts, videos, images, sounds and voices, application programs, or the like (which likewise applies to the following exemplary embodiments).

According to the distribution control device 1 in this exemplary embodiment, when information is distributed, the distribution can be efficiently controlled. A reason for that is as stated below.

It is because the distribution control device 1 is able to control the distribution of information according to the priority degree information associated with the information to be distributed.

Due to this, the distribution control device 1 is able to reduce the load on the communication network and the electric power consumption at the client terminal and the server device in comparison with the case where all information is distributed by the immediate processing mode. In particular, the client terminal that receives messages distributed from the distribution control device 1 can reduce the electric power consumption of the device itself. Therefore, the client terminal can restrain exhaustion of the battery.

Furthermore, the distribution control device 1 is able to shorten the delay time in distributing messages in comparison with the case where information is distributed in the accumulative processing mode.

A reason for that is that the distribution control device 1 distributes information whose priority degree is low in the accumulative processing mode at every predetermined time period. Furthermore, it is also because the distribution control device 1, when distributing information whose priority degree is high, is able also to distribute information whose priority degree is low and which has already been accumulated in the reception information 102. In other words, distributing information whose priority degree is low as well means that information is distributed before the predetermined time period is reached.

Moreover, the distribution control device 1 is able to guarantee the order in which to distribute pieces of information. A reason for that is that the distribution control device 1 is able to distribute pieces of information on the basis of the order in which the pieces of information were accumulated in the reception information 102.

### Second Exemplary Embodiment

Next, the second exemplary embodiment based fundamentally on the distribution control device 1 in accordance with the forgoing first exemplary embodiment of the present invention will be described. In the following description, portions characteristic of the present exemplary embodiment will be centrally described. In the description, configurations similar to those of the foregoing exemplary embodiments will be denoted by the same reference numbers, and redundant descriptions will be omitted.

A distribution control device 10 in the second exemplary embodiment of the present invention will be described with reference to FIG. 6.

FIG. 6 is a block diagram illustrating a configuration of a push distribution system 20 that includes the distribution control device 10 in the second exemplary embodiment of the present invention.

In FIG. 6, the push distribution system 20 includes, as main divisions, a push server 21 that includes the distribution control device 10, application servers 22, and portable terminal devices 23.

More specifically, the distribution control device 10 includes an information reception unit 11 and an information transmission unit 3. The information reception unit 11 includes a reception unit 12 of low-priority degree information and a reception unit 13 of high-priority degree information.

In FIG. 6, the distribution control device 10 is different from the distribution control device 1 described in conjunction with the first exemplary embodiment in that the information reception unit 11 includes the reception unit 12 of low-priority degree information and the reception unit 13 of high-priority degree information.

More specifically, the information reception unit 11 executes processing of step S1 to step S4 illustrated in FIG. 4. The reception unit 12 of low-priority degree information executes processing of step S6 to step S10 illustrated in FIG. 4. The reception unit 13 of high-priority degree information executes processing of step S5 illustrated in FIG. 4.

The application server 22 sets the push server 21 transmission request information 101 that contains the body of the message to be distributed, the destination ID capable of identifying a specific portable terminal device 23 that is a distribution target, and priority degree information.

Each portable terminal device 23 is, for example, a commonly known portable terminal device such as a smart phone or a cellular phone.

Each portable terminal device 23 includes an information reception unit 24. Each portable terminal device 23 provides a user with messages rearranged by the information reception unit 24. For example, the portable terminal device 23 provides the user with the messages via a user interface that the portable terminal device 23 has, such as a display.

More specifically, each information reception unit 24 may adopt a configuration that rearranges messages into the order in which the messages were received from the push server 21. Alternatively, for example, each information reception unit 24 may adopt a configuration that rearranges messages on the basis of information that is contained in the header of each message received and that indicates the order.

The application servers 22 and the portable terminal devices 23 are connected so that communication is possible (hereinafter, “connected so that communication is possible” is simply mentioned as “connected” in the present application) via a communication network 110.

The communication network 110 is, for example, one of various communication lines that cellular phone business operators own, one of general communication lines of the Internet or the like that Internet service providers or the like provide. However, the present invention described above using the present exemplary embodiment as an example is not limited by the foregoing configurations (which likewise applies to the following exemplary embodiments).

Thus, according to the distribution control device 10 in the present exemplary embodiment, the advantageous effects described in conjunction with the first exemplary embodiment can be enjoyed and, furthermore, distribution can be more quickly controlled.

A reason for that is that the information reception unit 11 of the distribution control device 10 further includes the reception unit 12 of low-priority degree information and the reception unit 13 of high-priority degree information. In other words, it is because the information reception unit 11 is able to disperse the processing according to the priority degree contained in the priority degree information.

(Hardware Configuration Example)

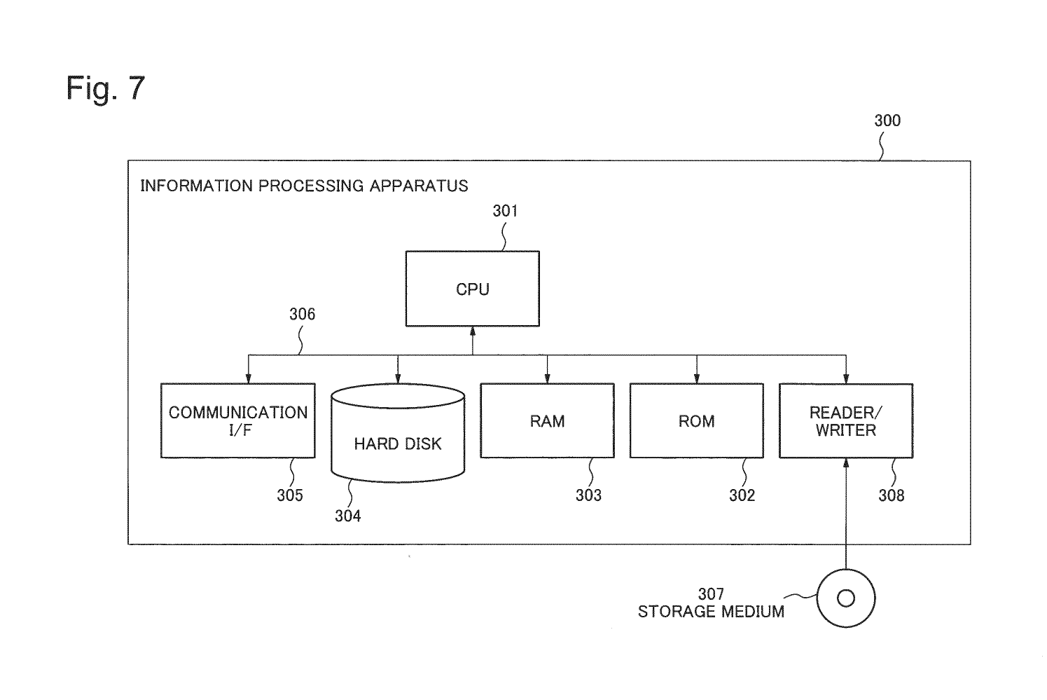

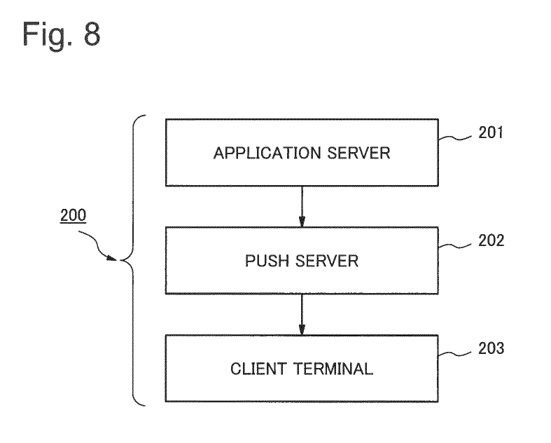

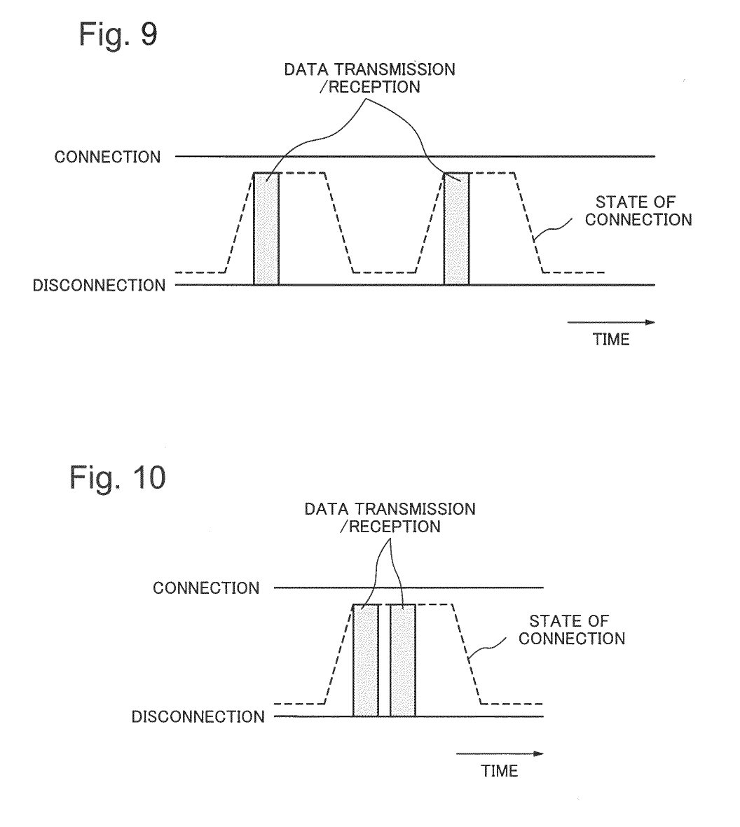

In the exemplary embodiments, the various portions illustrated in the drawings can be considered as functional units of software programs. These software (processing units, software modules) modules may be realized by dedicated hardware. However, groupings of the various portions illustrated in the drawings are configurations for convenience in description, and various configurations can be conceived at the time of actual mounting. An example of a hardware environment in this case will be described with reference to FIG. 7.

FIG. 7 is a diagram exemplarily illustrating a configuration of an information processing apparatus (computer) 300 capable of carrying out a distribution control device in accordance with a model exemplary embodiment of the present invention. In other words, FIG. 7 presents the configuration of the computer (information processing apparatus), such as a server, that is a hardware environment capable of realizing various functions in the exemplary embodiments described above. This computer is capable of realizing the whole or a part of the distribution control device (FIG. 1) or the distribution control device 10 (FIG. 6).

The information processing apparatus 300 illustrated in FIG. 7 is a common computer in which the following components are connected via a bus (communication line) 306.
a CPU (central processing unit) 301
a ROM (read-only memory) 302
a RAM (random access memory) 303
a hard disk 304 (memory device)
a communication interface (indicated as communication I/F (interface) in FIG. 7) 305 with an external device
a reader/writer 308 capable of reading and writing data that is stored in a storage medium 307 such as a CD-ROM (compact-disk read-only memory)

The present invention described using the foregoing exemplary embodiments as example is accomplished by the following procedure. The information processing apparatus 300 illustrated in FIG. 7 is supplied with a computer program capable of realizing the functions of the block diagrams (FIG. 1 and FIG. 6) or the flowcharts (FIG. 4 and FIG. 5) referred to in the description of the information processing apparatus 300. After that, the computer program is accomplished as it is read and executed by the CPU 301 of the hardware. Furthermore, it suffices that the computer program supplied in the apparatus is stored into a readable/writable temporarily memorizing memory (RAM 303) or a non-volatile storage device such as the hard disk 304.

Moreover, in the foregoing case, as for the method for supplying the computer program into the hardware, a presently common procedure can be adopted. Examples are a method in which the computer program is installed in the apparatus via a storage medium 307 of one of various kinds such as a CD-ROM, a method in which the computer program is downloaded via a communication line of the Internet or the like from an external device, or the like. In such a case, the present invention can be interpreted as being constructed by codes that constitute the foregoing computer program or a storage medium in which the codes are stored.

### INDUSTRIAL APPLICABILITY

The present invention is not limited by the various exemplary embodiments described above. The present invention can also be applied to the case where various information is provided to portable terminal devices and the like that include personal computers, POS (point-of-sale) systems, servers, and smart phones.

More specifically, as an example, the present invention is applicable to various services as indicated below.
Push distribution services that mobile communication business operators provide for third-party application providers.
Push type advertisement distribution services that advertisement distribution business operators provide for advertisers.
Mobile device management (MDM) systems that corporates introduce for the purpose of managing mobile terminals that employees use, and the like.

The invention of the present application has been described above with reference to the various exemplary embodiments. However, the invention of the present application is not limited by the foregoing various exemplary embodiments. In the configuration and details of the invention of the present application, various changes that a person skilled in the art can understand within the scope of the invention of the present application can be made.

This application claims the right of priority based on Japanese Patent Application No. 2013-121437 filed Jun. 10, 2013 and the entire disclosure thereof is incorporated herein.

### REFERENCE SIGNS LIST

1 distribution control device
2 information reception unit
3 information transmission unit
4 storage unit
10 distribution control device
11 information reception unit
12 reception unit of low-priority degree information
13 reception unit of high-priority degree information
20 push distribution system
21 push server
22 application server
23 portable terminal device
24 information reception unit
101 transmission request information
102 reception information
103 transmission information
110 communication network
200 push distribution system
201 application server
202 push server
203 client terminal
300 information processing apparatus
301 CPU
302 ROM
303 RAM
304 hard disk
305 communication interface
306 bus
307 storage medium
308 reader/writer

1. A distribution control device comprising:
an information reception unit configured to, in response to receiving transmission request information that contains an address ID capable of identifying a terminal that is a distribution target, a body of a message, and priority degree information that indicates a priority degree set for the message, determine the priority degree on the basis of the priority degree information, and to execute one of reception processing of high-priority degree information or reception processing of low-priority degree information in accordance with a result of determination; and
an information transmission unit configured to refer to transmission information containing the address ID and scheduled date and time of distribution of the message at every predetermined time period, and to acquire at least one first address ID associated with the scheduled date and time of distribution from the transmission information when the date and time of referring to the transmission information reaches the scheduled date and time of distribution, if it is indicated that the priority degree information is high, to acquire a first address ID in the transmission request information, and to distribute the at least one message by executing a distribution processing on the basis of the at least one first address ID acquired.

2. The distribution control device according to claim 1, wherein
the distribution processing, on the basis of the at least one first address ID acquired, refers to reception information that contains the transmission request information, distribution state information that indicates whether or not the message has been distributed, and date and time of request that indicates the date and time of receiving the transmission request information, acquires the body of the message associated with the first address ID from the reception information when the distribution state information associated with the first address ID indicates non-distribution, and, on the basis of the body of the message acquired and the first address ID, distributes at least one of the message, and, after distributing the message, stores information indicating that the message has been distributed into the distribution state information, and resets the scheduled date and time of distribution.

3. The distribution control device according to claim 1, wherein
the information transmission unit configured to, when distributing the at least one message, distribute the message in a chronological order of the date and time of request that indicates the date and time of receiving the transmission request information.

4. The distribution control device according to claim 1, wherein
the reception processing of low-priority degree information refers to the transmission information on the basis of the address ID contained in the transmission request information, determines whether or not the scheduled date and time of distribution associated with the address ID has been set, and, if it is determined that the scheduled date and time of distribution has not been set, generates the scheduled date and time of distribution through a predetermined calculation and stores the scheduled date and time of distribution generated and the address ID into the transmission information.

5. The distribution control device according to claim 1, wherein
the reception processing of high-priority degree information notifies the information transmission unit that the priority degree information is high.

6. The distribution control device according to claim 2, wherein
the information reception unit configured to, in response to receiving the transmission request information, store into the reception information the address ID contained in the transmission request information, the body of the message, the priority degree information, a message ID capable of identifying the transmission request information, the date and time of request, and the distribution state information.

7. A push distribution system comprising:
the distribution control device according to claim 1.

8. A distribution control method by an information processing apparatus comprising:
in response to receiving transmission request information that contains an address ID capable of identifying a terminal that is a distribution target, a body of a message, and priority degree information that indicates a priority degree set for the message, determining the priority degree on the basis of the priority degree information, and executing one of reception processing of high-priority degree information or reception processing of low-priority degree information in accordance with a result of determination and
referring to transmission information containing the address ID and scheduled date and time of distribution of the message at every predetermined time period, and acquiring at least one first address ID associated with the scheduled date and time of distribution from the transmission information when the date and time of referring to the transmission information reaches the scheduled date and time of distribution, if it is indicated that the priority degree information is high, acquiring a first address ID in the transmission request information, and
distributing the at least one message by executing a distribution processing on the basis of the at least one first address ID acquired.

9. The distribution control method according to claim 8, wherein
on the basis of the at least one first address ID acquired, referring to reception information that contains the transmission request information, distribution state information that indicates whether or not the message has been distributed, and date and time of request that indicates the date and time of receiving the transmission request information,
acquiring the body of the message associated with the first address ID in the reception information when the distribution state information associated with the first address ID indicates non-distribution,
on the basis of the body of the message acquired and the first address ID, distributing at least one of the message, and,
storing information indicating that the message has been distributed into the distribution state information after distributing the message, and
resetting the scheduled date and time of distribution.

10. A non-transitory computer readable storage medium that causes a computer to implement:
a function that, in response to receiving transmission request information that contains an address ID capable of identifying a terminal that is a distribution target, a body of a message, and priority degree information that indicates a priority degree set for the message, determines the priority degree on the basis of the priority degree information, and executing, one of reception processing of high-priority degree information or reception processing of low-priority degree information in accordance with a result of determination, and
a function that refers to transmission information containing the address ID and scheduled date and time of distribution of the message at every predetermined time period, and acquiring at least one first address ID associated with the scheduled date and time of distribution from the transmission information when the date and time of having referring to the transmission information reaches the scheduled date and time of distribution, if it is indicated that the priority degree information is high, acquiring a first address ID in the transmission request information, and distributing the at least one message by executing a distribution processing on the basis of the at least one first address ID acquired.

11. The distribution control device according to claim 2, wherein
the information transmission unit configured to, when distributing the at least one message, distribute the message in a chronological order of the date and time of request that indicates the date and time of receiving the transmission request information.

12. The distribution control device according to claim 3, wherein
the information reception unit configured to, in response to receiving the transmission request information, store into the reception information the address ID contained in the transmission request information, the body of the message, the priority degree information, a message ID capable of identifying the transmission request information, the date and time of request, and the distribution state information.

13. The distribution control device according to claim 4, wherein
the information reception unit configured to, in response to receiving the transmission request information, store into the reception information the address ID contained in the transmission request information, the body of the message, the priority degree information, a message ID capable of identifying the transmission request information, the date and time of request, and the distribution state information.

14. The distribution control device according to claim 5, wherein
the information reception unit configured to, in response to receiving the transmission request information, store into the reception information the address ID contained in the transmission request information, the body of the message, the priority degree information, a message ID capable of identifying the transmission request information, the date and time of request, and the distribution state information.

15. A push distribution system comprising:
the distribution control device according to claim 2.

16. A push distribution system comprising:
the distribution control device according to claim 3.

17. A push distribution system comprising:
the distribution control device according to claim 4.

18. A push distribution system comprising:
the distribution control device according to claim 5.

19. A push distribution system comprising:
the distribution control device according to claim 6.

20. A push distribution system comprising:
the distribution control device according to claim 11.
